(19) United States
(12) Patent Application Publication
(10) Pub. No.: US 2021/0282897 A1
(43) Pub. Date: Sep. 16, 2021

(54) DENTAL MODEL AND DIE ASSEMBLY AND METHOD OF MAKING THE SAME

(71) Applicant: Carbon, Inc., Redwood City, CA (US)

(72) Inventor: Kyle Laaker, Redwood City, CA (US)

(21) Appl. No.: 16/606,317

(22) PCT Filed: Mar. 28, 2018
(86) PCT No.: PCT/US2018/024842

§ 371 Date: Oct. 18, 2019

Related U.S. Application Data
(60) Provisional application No. 62/488,284, filed on Apr. 21, 2017.
(60) Provisional application No. 62/490,995, filed on Apr. 27, 2017.

(51) Int. Cl. A61C 5/70; A61C 13/34; A61C 13/00

(52) U.S. Cl. CPC A61C 5/70; A61C 13/0013; A61C 13/0019; A61C 13/34

(57) ABSTRACT

An assembly useful for preparing a prosthetic crown for fitting to a tooth of a patient is accordingly described herein. The assembly includes (a) a polymer dental model having a shape corresponding to at least a portion of a dental arch of a patient and a socket formed therein, the socket having a socket wall, and (b) a polymer die having an upper portion configured in the shape of a tooth of a patient and a lower stem configured for insertion into the socket. At least one of the stem and the socket wall are configured to have both a relaxed position when the die is not in the socket, and a tensioned position when the die is fully inserted in the socket, so that the stem is firmly and accurately engaged by the socket when the die is inserted therein.

### RELATED APPLICATIONS

This applications claims priority to U.S. Provisional Application Ser. No. 62/488,284, filed Apr. 21, 2017, the disclosure of which is hereby incorporated by reference in its entirety.

### FIELD OF THE INVENTION

The present invention concerns dental models and dies and methods of making the same, particularly models and dies useful for preparing prosthetic crowns, and models and dies particularly adapted for additive manufacturing.

### BACKGROUND

Dental models and dies are used to prepare prosthetic crowns for patients, typically in labs where the crowns are manufactured, and then tested and modified by dental artisans as required, before they are sent to the dentist for fitting onto a previously prepared tooth of a patient (See, e.g., U.S. Pat. No. 7,328,077). Because humans are so sensitive to even slight mis-alignments between their teeth, a high level of accuracy for such models is required (See, e.g., U.S. Pat. No. 8,738,340).

Currently, the most accurate dental models and dies are milled from larger blocks of materials on five-axis milling machines. While accurate, such machines are expensive, and can be slow. And, speed of manufacture is important, because temporary crowns can be fragile, and a patient's teeth can shift surprisingly quickly if the permanent crown is not promptly installed (potentially requiring the manufacture of an entirely new crown).

Additive manufacturing techniques would seem ideally suited to the production of dental models and dies. Unfortunately, the more accurate techniques, such as jet-printing methods, can be extremely slow (for example, requiring approximately five hours to produce the model), and can generate objects with poor material and handling properties. The more rapid techniques (such as stereolithography), on the other hand, can sometimes produce models and dies with less accuracy than desired—with accuracy declining as speed is increased. U.S. Pat. No. 9,375,298 to Boronkay et al. describes dental models and dies that can be made by additive manufacturing techniques generally, but—among other things—in at least some embodiments requires small complicated features such as cantilever springs that typically require slower production during additive manufacturing. Accordingly, new techniques for adapting additive manufacturing to the production of dental models and dies are needed.

### SUMMARY

The present invention provides methods and products that are particularly suitable for the rapid manufacture of dental models and dies by additive manufacturing, with acceptable levels of accuracy.

In some embodiments, shrinkage of the polymerizable liquid or resin during or after additive manufacturing serves to warp portions of the models and/or dies in a manner that enhances the tensioning action between the two, and facilitates the production of simpler tensioning features that can be more rapidly produced by additive manufacturing.

An assembly useful for preparing a prosthetic crown for fitting to a tooth of a patient is accordingly described herein, which assembly is particularly suitable for production by additive manufacturing at suitable speeds and with acceptable accuracy. The assembly includes (a) a polymer dental model having a shape corresponding to at least a portion of a dental arch of a patient and a socket formed therein, the socket having a socket wall, and (b) a polymer die having an upper portion configured in the shape of a tooth of a patient and a lower stem configured for insertion into the socket. At least one (or both) of the stem and the socket wall are configured to have both a relaxed position when the die is not in the socket, and a tensioned position when the die is fully inserted in the socket, so that the stem is firmly and accurately (e.g., plus or minus 20 microns in the mesial-distal axis of the arch or arch portion, and/or plus or minus 20 microns in the buccal-lingual axis of the arch or arch portion) engaged by the socket when the die is inserted therein.

In some embodiments, the assembly includes: (a) a polymer dental model having a shape corresponding to at least a portion of a dental arch of a patient, the model having (i) a bottom surface portion and (ii) a socket formed in the model in a location corresponding to a tooth of a patient, to which tooth a crown is to be fitted, with the socket extending through the bottom surface portion, and with the socket having a side wall and an irregularly shaped circumference; and (b) a polymer die having an upper portion configured in the shape of a tooth of a patient prepared to receive a crown and a lower stem configured for insertion into the socket, with the stem having (i) a bottom surface portion and (ii) an irregularly shaped circumference corresponding to that of the socket, the stem and socket together configured so that the die inserts into the socket in one orientation only; with the stem comprising at least two (three, four, etc.) separate elongate prongs configured for insertion into the socket, each the prongs having a laterally relaxed position and a laterally (inwardly compressed) tensioned position; and with the prongs configured so that upon insertion into the socket with the stem bottom portion co-planar with the dental model bottom portion, the prongs in the tensioned position frictionally engage the socket wall and securely position the die in the model in a predetermined position (plus or minus 20 microns in the mesial-distal axis of the arch or arch portion, and/or plus or minus 20 microns in the buccal-lingual axis of the arch or arch portion). In some embodiments, the prongs are either (i) free of one another adjacent the bottom surface portion, or (ii) connected to one another adjacent the bottom surface portion. In some embodiments, the prongs in the relaxed position are warped away from one another.

In some embodiments, the assembly includes: (a) a polymer dental model having a shape corresponding to at least a portion of a dental arch of a patient, the model having (i) a bottom surface portion and (ii) a socket formed in the model in a location corresponding to a tooth of a patient, to which tooth a crown is to be fitted, with the socket extending through the bottom surface portion, and with the socket having a side wall and an irregularly shaped circumference; and (b) a polymer die having an upper portion configured in the shape of a tooth of a patient prepared to receive a crown and a lower stem configured for insertion into the socket, with the stem having (i) a bottom surface portion and (ii) an irregularly shaped circumference corresponding to that of the socket, the stem and socket together configured so that the die inserts into the socket in one orientation only; with the socket comprising at least one, or a plurality of, wall portions (e.g., formed by at least one slot formed therein) having a laterally relaxed position and a laterally (outwardly compressed) tensioned position; and with the wall portions configured so that upon insertion into the socket with the stem bottom portion co-planar with the dental model bottom portion, the wall portions in the tensioned position frictionally engage the stem and securely position the die in the model in a predetermined position (plus or minus 20 microns in the mesial-distal axis, and/or plus or minus 20 microns in the buccal-lingual axis).

In some embodiments, the stem in the tensioned position, and the socket, are inwardly tapered in a corresponding mating configuration (e.g., up to six degrees from vertical).

In some embodiments, the socket has a top opening and a bottom opening, the socket top opening has a circumference greater than the socket bottom opening, the socket side wall tapers inwardly from the socket top opening to the socket bottom opening; and the stem bottom portion has a circumference intermediate between that of the socket top opening and that of the socket bottom opening.

In some embodiments, the stem further comprises a narrowed foot portion adjacent the bottom surface portion.

In some embodiments, both the model and the die are comprised of poly(acrylate), poly(methacrylate), poly(urethane acrylate), poly(urethane methacrylate), poly(epoxy acrylate), or poly(epoxy methacrylate).

In some embodiments, both the model and the die consist of a polymer having: a tensile modulus of 1200 or 1600 MPa to 3000 MPa, or more; an elongation at break of 2% to 100 or 140%, or more; a flexural strength of 40 or 60 MPa, to 100 or 120 MPa, or more; and/or a flexural modulus (chord, 0.5%-1% strain) of 1500 or 2000 MPa, to 3000 MPa, or more.

In some embodiments, both the dental model and the die are produced by additive manufacturing (preferably stereolithography, more preferably bottom-up stereolithography, most preferably continuous liquid interface production (CLIP)) from a polymerizable resin.

In some embodiments, the dental model is layerless, the die is layerless, or both the dental model and the die are layerless.

In some embodiments, a method of making an assembly as described herein includes (a) producing both the die and the model from a light-polymerizable resin by stereolithography, preferably bottom-up stereolithography, and then (b) optionally washing the die and the model. In some embodiments, the resin shrinks during or after the producing step, and wherein the prongs warp away from one another during or after the producing step (e.g., by producing the die on a carrier platform with the bottom portion of the prongs contacting the carrier platform and then separating the die from the carrier platform; by flood illumination of the exterior of the die; by combinations thereof). In some embodiments, the producing step is carried out in a time of not more than one hour. In some embodiments, the producing step is carried out on a stereolithography apparatus including a carrier platform, and the producing step comprises simultaneously producing the die and the model on the same carrier platform. In some embodiments, the bottom-up stereolithography comprises continuous liquid interface production.

The foregoing and other objects and aspects of the present invention are explained in greater detail in the drawings herein and the specification set forth below. The disclosures of all United States patent references cited herein are to be incorporated herein by reference.

### BRIEF DESCRIPTION OF THE DRAWINGS

FIG. 1 is a perspective view, exploded, of a die and model assembly of the present invention.

FIG. 2 is a perspective view of the die and model assembly of FIG. 1, with dies inserted into their respective sockets.

FIG. 3 is a first enlarged, perspective, view of the pair of dies of FIG. 1-2.

FIG. 4 is a second enlarged, perspective, view of the pair of dies of FIGS. 1-2.

FIG. 5 is a third enlarged, perspective, view of the pair of dies of FIGS. 1-2, showing the bottom surface portions of each thereof.

FIG. 6 is a side view of one of the dies of FIGS. 1-5 above, with the prongs in both their relaxed and compressed positions.

FIG. 7 is a side view of the dies of FIGS. 1-6.

FIG. 8 provides a top view, and a sectional view (looking downward), of each of the dies shown in FIG. 7.

FIG. 9 is a bottom, perspective, view of a die of FIGS. 1-7 fitted into the model of FIGS. 1-2, as in FIG. 2, with the bottom surface portions of the model and the die being co-planar with one another.

FIG. 10 is a bottom view of the model and die assembly of FIG. 2, showing the bottom portions of the model and stem being co-planar with one another, and the prongs of the stem in their tensioned, or inwardly compressed, positions.

FIG. 11 is a highly schematic, top, view of an arch model and socket of the invention, with nomenclature concerning anatomical orientations provided for clarity.

FIG. 12 is a bottom, perspective, view of a die of FIG. 1-7, along with an alternate embodiment thereof in which the prongs are re-joined at the bottom terminal, or “foot” portion thereof.

FIG. 13 is a side view of the two embodiments of dies shown in FIG. 12.

FIG. 14 is a sectional view of thee two embodiments of dies shown in FIG. 13. Looking downward.

FIG. 15A is a side schematic view of a die produced on a carrier platform by bottom-up stereolithography in an embodiment of the present invention.

FIG. 15B is a side schematic view of the die of FIG. 15A after separation from the carrier platform, showing the prongs warping away from one another.

FIG. 15C is a top-down, sectional, view of the die of FIG. 15B, showing the prongs warping away frome one aother (one prong is shaped differently to impart an irregular shape to the overall stem, so that it is insertable into a corresponding socket in one orientation only).

FIG. 16 is a top-down, sectional, view of a socket wall of a model of the present invention, where the model is hollow and the socket wall is segmented, and the segments of the wall warped towards one another.

The present invention is explained in greater detail in the drawings herein and the specification set forth below. The disclosures of all United States patent references cited herein are to be incorporated by reference herein in their entirety.

### DETAILED DESCRIPTION

The present invention relates to compression materials, and particularly concerns constant force compression materials.

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

As used herein, the term “and/or” includes any and all possible combinations or one or more of the associated listed items, as well as the lack of combinations when interpreted in the alternative (“or”).

Like numbers are assigned to analogous elements in the Figures herein and discussed below, generally differentiated by an alphabetic suffix or an apostrophe.

### 1. Additive Manufacturing Methods and Apparatus

The intermediate object is preferably formed from polymerizable resins by additive manufacturing, particularly stereolithography, and preferably bottom-up stereolithography. Such methods are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication Nos. 2013/0292862 to Joyce, and US Patent Application Publication No. 2013/0295212 to Chen et al. Such techniques typically involve projecting light through a window above which a pool of resin (or polymerizable liquid) is carried. A general purpose or functional part carrier is typically positioned above the window and above the pool, on which the growing object is produced.

In some embodiments of the present invention, the intermediate object is formed by continuous liquid interface production (CLIP). CLIP is known and described in, for example, PCT Applications Nos. PCT/US2014/015486 (published as U.S. Pat. No. 9,211,678 on Dec. 15, 2015); PCT/US2014/015506 (also published as U.S. Pat. No. 9,205,601 on Dec. 8, 2015), PCT/US2014/015497 (also published as U.S. Pat. No. 9,216,546 on Dec. 22, 2015), and in J. Tumbleston, D. Shirvanyants, N. Ermoshkin et al., Continuous liquid interface production of 3D Objects, Science 347, 1349-1352 (published online 16 Mar. 2015). See also R. Janusziewcz et al., Layerless fabrication with continuous liquid interface production, Proc. Natl. Acad. Sci. USA 113, 11703-11708 (Oct. 18, 2016). In some embodiments, CLIP employs features of a bottom-up three dimensional fabrication as described above, but the irradiating and/or the advancing steps are carried out while also concurrently maintaining a stable or persistent liquid interface between the growing object and the build surface or window, such as by: (i) continuously maintaining a dead zone of polymerizable liquid in contact with the build surface, and (ii) continuously maintaining a gradient of polymerization zone (such as an active surface) between the dead zone and the solid polymer and in contact with each thereof, the gradient of polymerization zone comprising the first component in partially cured form.

In some embodiments of CLIP, the optically transparent member comprises a semipermeable member (e.g., a fluoropolymer), and the continuously maintaining a dead zone is carried out by feeding an inhibitor of polymerization through the optically transparent member, thereby creating a gradient of inhibitor in the dead zone and optionally in at least a portion of the gradient of polymerization zone. Other approaches for carrying out CLIP that can be used in the present invention and potentially obviate the need for a semipermeable “window” or window structure include utilizing a liquid interface comprising an immiscible liquid (see L. Robeson et al., WO 2015/164234, published Oct. 29, 2015), generating oxygen as an inhibitor by electrolysis (see I. Craven et al., WO 2016/133759, published Aug. 25, 2016), and incorporating magnetically positionable particles to which the photoactivator is coupled into the polymerizable liquid (see J. Rolland, WO 2016/145182, published Sep. 15, 2016).

In some embodiments, the additive manufacturing apparatus can be a Carbon, Inc. M1 or M2 apparatus implementing continuous liquid interface production, available from Carbon, Inc., 1089 Mills Way, Redwood City, Calif. 94063 USA.

2. Resins.

Resins, or photopolymerizable liquids, used in carrying out the methods of the invention, can be conventional resins, or dual cure resins (that is, resins requiring further cure following additive manufacturing, such as a baking step). Numerous suitable resins are known and include, but are not limited to those described in the references above. In some embodiments, dual cure resins such as described in U.S. Pat. Nos. 9,453,142 or 9,598,606 to Rolland et al., can be used.

In some embodiments, the resin is one which, when polymerized to produce the model and die, produces a model and die comprised of poly(acrylate), poly(methacrylate), poly(urethane acrylate), poly(urethane methacrylate), poly(epoxy acrylate), or poly(epoxy methacrylate).

In some embodiments, the resin is one which, when polymerized to produce the model and die, produces a model and die comprising or consisting of a polymer having:

a tensile modulus of 1200 or 1600 MPa to 3000 MPa, or more;

an elongation at break of 2% to 100 or 140%, or more;

a flexural strength of 40 or 60 MPa, to 100 or 120 MPa, or more; and/or

a flexural modulus (chord, 0.5%-1% strain) of 1500 or 2000 MPa, to 3000 MPa, or more.

In some embodiments, the resin is one which shrinks during or following photopolymerization, at least sufficiently to allow warping of the prongs that comprise the stem of the die away from one another, which in turn serves to enhance the tensioning performance of the prongs when inserted into a socket, as discussed above and below.

Particular examples of suitable resins include, but are not limited to, Carbon, Inc., UMA resins (particularly PR25 resin in the UMA resin family), as well as Carbon, Inc. RPU and EPX dual cure resins, available from Carbon, Inc., 1089 Mills Way, Redwood City, Calif. 94063 USA.

3. Dental MOdels and Arches

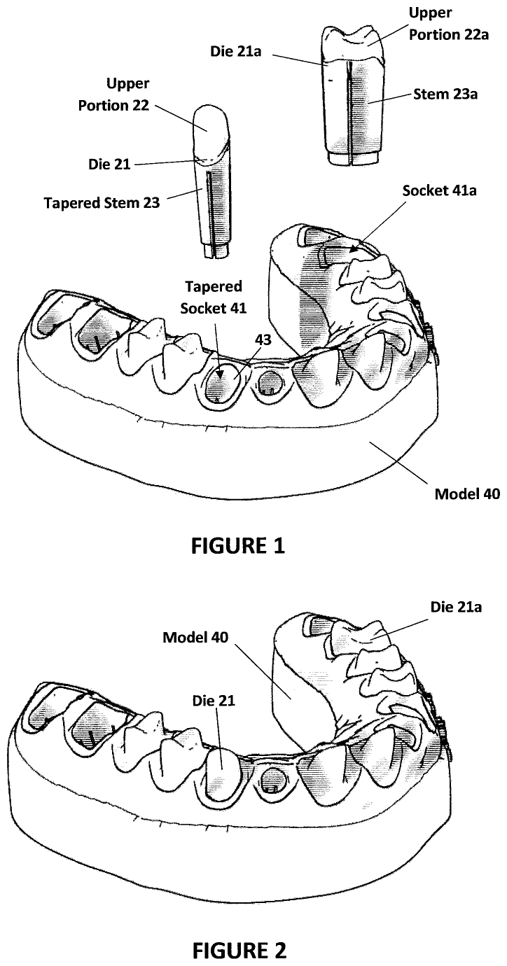

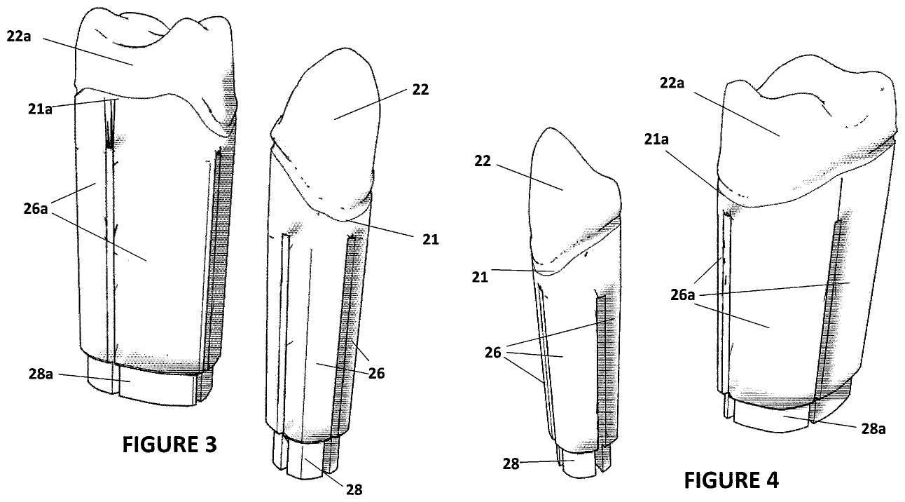

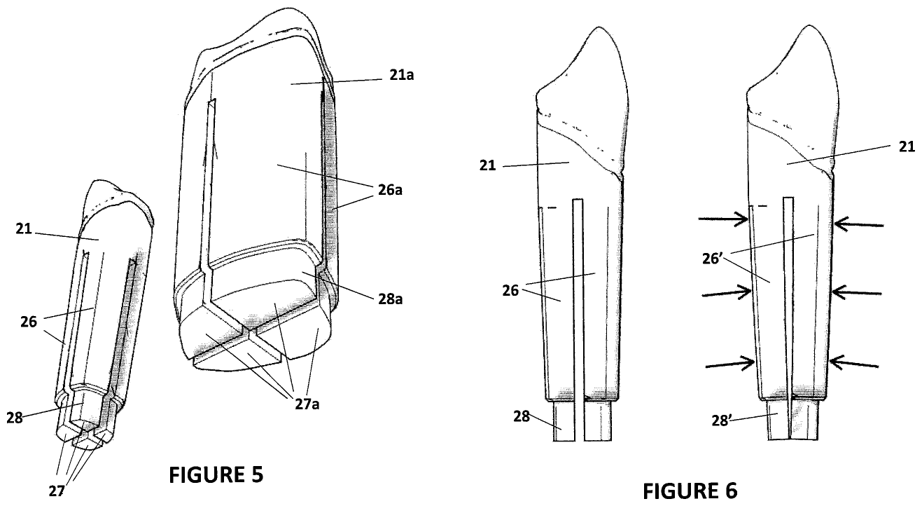

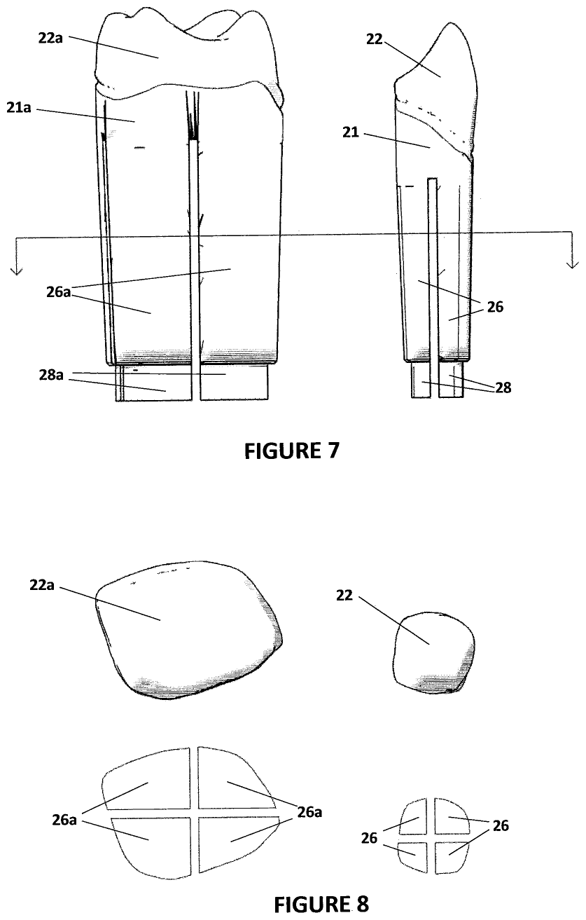

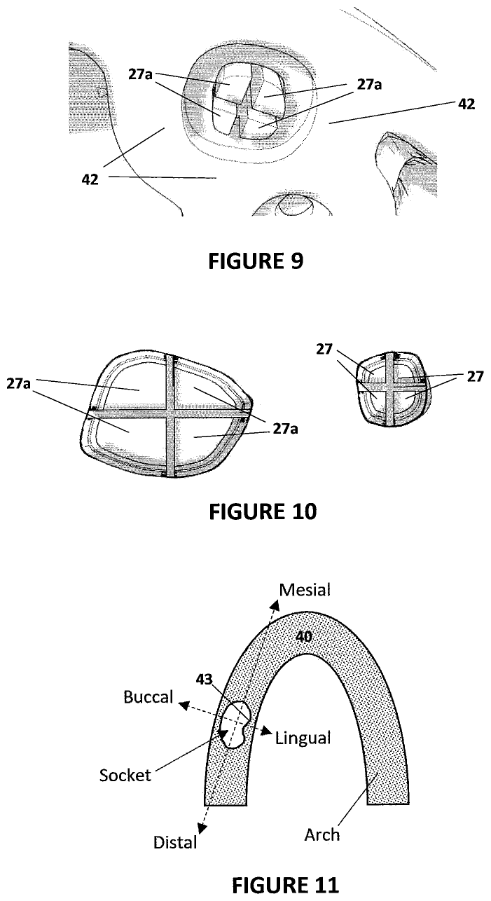

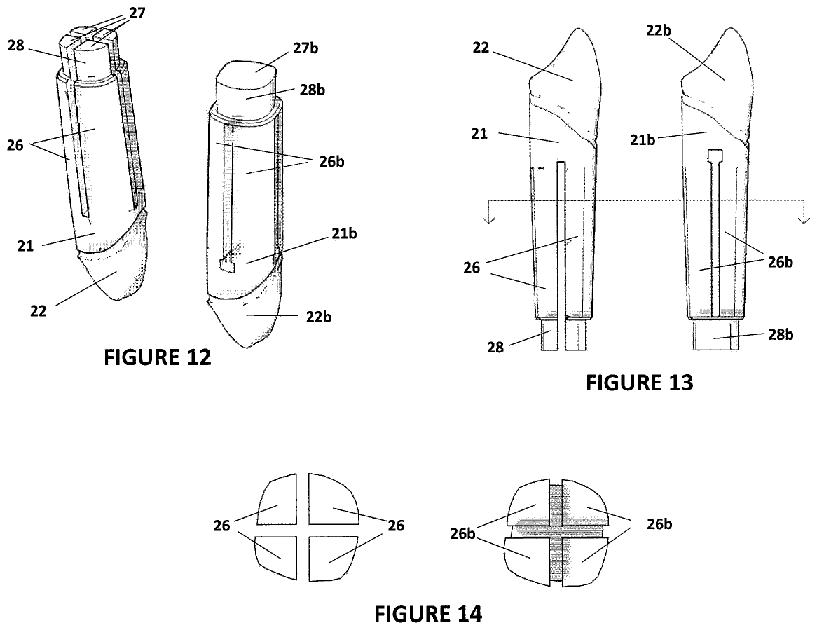

A first non-limiting example of the present invention is shown in FIGS. 1-10 herein, and a second embodiment is shown in FIGS. 12-14 herein. Anatomical terms are illustrated in FIG. 11 for convenient reference. Numerous additional embodiments will be readily envisioned by those skilled in the art.

Tensioning dies. A first non-limiting embodiment of the present invention is an assembly useful for preparing a prosthetic crown for fitting to a tooth of a patient, the assembly including: (a) a polymer dental model (e.g., 40) having a shape corresponding to at least a portion of a dental arch of a patient, the model having (i) a bottom surface portion (e.g., 42) and (ii) a socket (e.g., 41, 41a) formed in the model in a location corresponding to a tooth of a patient, to which tooth a crown is to be fitted, with the socket extending through the bottom surface portion, and with the socket having a side wall and an irregularly shaped circumference (e.g., 43 in FIG. 11); and (b) a polymer die (e.g., 21, 21a, 21b) having an upper portion (e.g., 22, 22a, 22b) configured in the shape of a tooth of a patient prepared to receive a crown and a lower stem (e.g., 23, 23a, 23b) configured for insertion into the socket, with the stem having (i) a bottom surface portion (e.g., 27, 27a, 27b) and (ii) an irregularly shaped circumference corresponding to that of the socket, the stem and socket together configured so that the die inserts into the socket in one orientation only; with the stem comprising at least two (three, four, etc.) separate elongate prongs (e.g., 26, 26a, 26b) configured for insertion into the socket, each the prongs having a laterally relaxed position and a laterally (inwardly compressed) tensioned position (e.g., 26′ in FIG. 6); and with the prongs configured so that upon insertion into the socket with the stem bottom portion co-planar with the dental model bottom portion, the prongs in the tensioned position frictionally engage the socket wall and securely position the die in the model in a predetermined position (plus or minus 20 microns in the mesial-distal axis of the arch or arch portion, and/or plus or minus 20 microns in the buccal-lingual axis of the arch or arch portion).

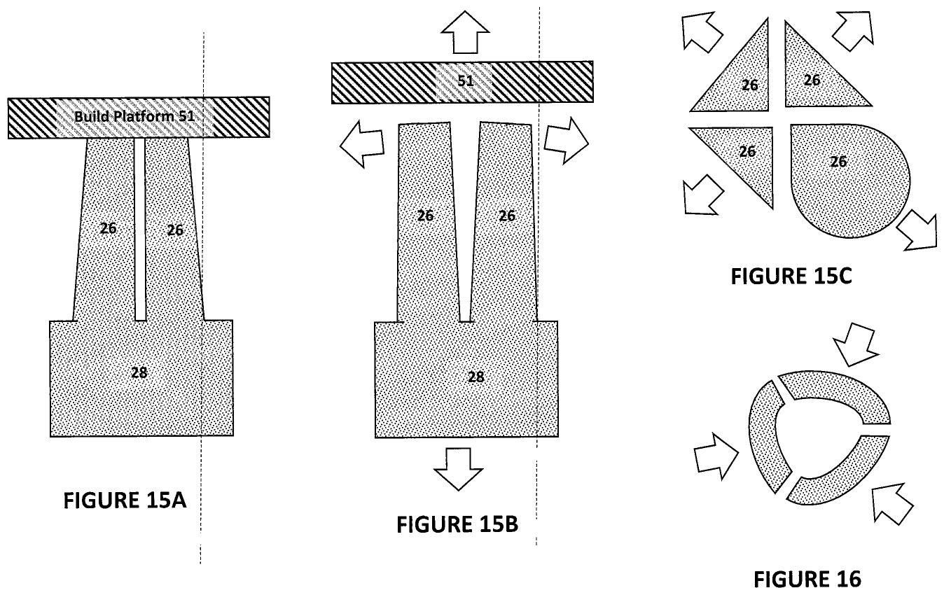

The stem and socket are both tapered (downwardly) as will be seen in the Figures (and note the dashed vertical line in FIGS. 15A-15B. In the case of the stem (which is comprised of the prongs), it is typically tapered in both the relaxed and tensioned position (though more so in the tensioned position). The taper of the stem in the tensioned position (and hence the corresponding taper in the socket, is, on average (the stem and socket being irregularly configured as noted above), from 0.1 or 0.2 degrees, up to six degrees. In some embodiments, the tapered configuration may provide for ease of die insertion and removal, e.g., such that there is relatively low friction at the beginning of insertion and, by comparison, a higher degree of friction in the fully inserted position. This configuration may further permit the dies to be pushed or “popped” in and out with a generally axial force, and in some embodiments, a locking mechanism, such as bumps or detents, may not be needed and may be omitted. Moreover, once the die is released or “popped” out of the fully inserted position, it may be progressively easier to remove due to the decrease of friction.

Note that, while the bottom portions of the dies are shown entirely flat (which assists when they must be pressed out of the die for handling and modeling, and assists in additive manufacturing on a build plate), they may be irregular in shape, so long as one portion extends down to a co-planar or “indexing” position with the bottom surface portion of the model.

In embodiments of the foregoing, the prongs may be either either (i) free of one another adjacent the bottom surface portion (such as in the embodiment of FIGS. 1-10), or (ii) connected to one another adjacent the bottom surface portion (such as in the embodiment shown in FIGS. 12-14).

Tensioning models. While not shown in the Figures, a reciprocal arrangement to that shown in FIGS. 1-10 can be readily envisioned, where tensioning is provided by the model rather than the die. Such an assembly generally includes: (a) a polymer dental model having a shape corresponding to at least a portion of a dental arch of a patient, the model having (i) a bottom surface portion and (ii) a socket formed in the model in a location corresponding to a tooth of a patient, to which tooth a crown is to be fitted, with the socket extending through the bottom surface portion, and with the socket having a side wall and an irregularly shaped circumference; and (b) a polymer die having an upper portion configured in the shape of a tooth of a patient prepared to receive a crown and a lower stem configured for insertion into the socket, with the stem having (i) a bottom surface portion and (ii) an irregularly shaped circumference corresponding to that of the socket, the stem and socket together configured so that the die inserts into the socket in one orientation only; with the socket comprising at least one, or a plurality of, wall portions (e.g., formed by at least one slot formed therein) having a laterally relaxed position and a laterally (outwardly compressed) tensioned position; and with the wall portions configured so that upon insertion into the socket with the stem bottom portion co-planar with the dental model bottom portion, the wall portions in the tensioned position frictionally engage the stem and securely position the die in the model in a predetermined position (plus or minus 20 microns in the mesial-distal axis, and/or plus or minus 20 microns in the buccal-lingual axis).

In general, tensioning models are at least partially hollow, so that the wall of the socket can be made resilient or displacable between relaxed and tensioined positions—for example, by forming one, two or more slots extending partially or fully through the socket wall, and extending from the bottom surface portion of the model up to, or partially up to, the upper or outer (anatomic) surface of the model.

Additional features. Additional features can be incorporated to the embodiments set forth above. For example, and as discussed further below, both the dental model and the die are preferably produced by additive manufacturing (preferably stereolithography, more preferably bottom-up stereolithography, most preferably continuous liquid interface production (CLIP)) from a polymerizable resin.

In general, it will be seen that the socket has a top opening and a bottom opening, the socket top opening has a circumference greater than the socket bottom opening, the socket side wall tapers inwardly from the socket top opening to the socket bottom opening; and the stem bottom portion has a circumference intermediate between that of the socket top opening and that of the socket bottom opening.

In some embodiments, the stem has an external surface and the socket has an internal surface, and a major portion of both the surfaces contact one another when the stem is inserted into the socket with the stem bottom portion and the dental model bottom portion co-planar with one another.

In some embodiments, the assembly further includes friction bars formed on the stem, the socket side wall portion (as can be seen in FIGS. 1-2), or both.

While not illustrated, it will be appreciated that there can optionally, but in some embodiments preferably, included: a detent formed on either the socket side wall or the stem, and a corresponding detent recess formed on the other of the socket side wall or the stem, with the detent and detent recess configured to engage one another when the die is inserted into the socket with the stem bottom portion and the dental model bottom portion co-planar with one another. In some embodiments, the stem further comprises a narrowed foot portion (e.g., 28, 28a, 28b) adjacent the bottom surface portion, which foot portion can reside within an enlarged hollow adjacent the model bottom surface, and assist in convenient press-removal of the die from the model by a dental artisan.

Methods of making. As noted above, the assemblies described herein are particularly suitable for adapting additive manufacturing methods to dental labs, with an acceptable balance of speed and accuracy. Particular methods and resins useful therein are as described above.

Thus, a further aspect of the invention is a method of making an assembly as described herein, including the steps of: (a) producing both the die and the model from a light-polymerizable resin by stereolithography, preferably bottom-up stereolithography, and then (b) optionally washing the die and the model. The die and model can then be used by a dental artisan for test fitting and modifying a crown before the crown is delivered to a dentist for fitting to a patient.

Preferably, the producing step is carried out in a time of not more than one hour.

Preferably, the producing step is carried out on a stereolithography apparatus including a carrier platform (also referred to as a build platform), and the producing step comprises simultaneously producing the die and the model on the same carrier platform.

And preferably, as indicated above, the bottom-up stereolithography comprises continuous liquid interface production.

Warping. Warping of the prongs during or after additive production can be carried out by any suitable technique, or combination of techniques. For example (and as schematically illustrated in FIGS. 15A-15C, the die can be formed on a carrier platform 51 with the bottom surface of the prongs 26 contacting the carrier platform. By additively manufacturing the die with the prongs so constrained (such as by stereolithography), internal stresses in the prongs will cause the prongs to warp outwardly from one another when they are separated from the carrier platform. Another approach (which can be implemented independently or in combination with the foregoing) is to flash flood-curing the outer surface of the die (but not the interior), for example in an ultraviolet light box. This causes a bimetallic-like behavior as the outer surface shrinks more and contracts, while the interior remains larger, causing the legs to warp away from one another.

For the converse configuration (tensioning feature in socket), note also that, when the model is hollow and produced in similar manner with the bottom surface (or more specifically, bottom edge portions) produced in contact to the carrier plate, a similar inward warpage upon separation from the carrier platform can be obtained when the socket inner wall is segmented by one, two or more vertical slots, thus warping the socket wall segments inward. And similarly, flood illumination from the (with the bottom of the model on an optically opaque surface) top can cause greater shrinkage of such a segmented socket wall from the interior, again warping wall segments inward. See for example FIG. 16, which is a top-down, sectional, view of a socket wall of a model of the present invention, taken about half way down the socket. The socket wall segments are integral with the model wall outer portion (visible in FIG. 1), but each bottom wall segment is free to warp inward.

4. Post-Production Steps.

As noted above, a further aspect of the invention is a method of making at least one object, comprising the steps of: (a) providing a composite article as described herein; (b) optionally, but in some embodiments preferably, washing the object (e.g., with a wash liquid comprising an organic solvent); then (c) optionally (depending on the choice of resin) further curing the composite article (e.g., by heating).

Washing. After the intermediate object is formed, it is optionally washed (e.g., with an organic solvent), optionally dried (e.g., air dried) and/or rinsed (in any sequence).

Solvents (or “wash liquids”) that may be used to carry out the present invention include, but are not limited to, water, organic solvents, and combinations thereof (e.g., combined as co-solvents), optionally containing additional ingredients such as surfactants, chelants (ligands), enzymes, borax, dyes or colorants, fragrances, etc., including combinations thereof. The wash liquid may be in any suitable form, such as a solution, emulsion, dispersion, etc.

Examples of organic solvents that may be used as a wash liquid, or as a constituent of a wash liquid, include, but are not limited to, alcohol, ester, dibasic ester, ketone, acid, aromatic, hydrocarbon, ether, dipolar aprotic, halogenated, and base organic solvents, including combinations thereof. Solvents may be selected based, in part, on their environmental and health impact (see, e.g., GSK Solvent Selection Guide 2009). Additional examples include hydrofluorocarbon solvents (e.g., 1,1,1,2,3,4,4,5,5,5-decafluoropentane (Vertrel® XF, DuPont™ Chemours), 1,1,1,3,3-Pentafluoropropane, 1,1,1,3,3-Pentafluorobutane, etc.); hydrochloro-fluorocarbon solvents (e.g., 3,3-Dichloro-1,1,1,2,2-pentafluoropropane, 1,3-Dichloro-1,1,2,2,3-pentafluoropropane, 1,1-Dichloro-1-fluoroethane, etc.); hydrofluorether solvents(e.g., methyl nonafluorobutyl ether (HFE-7100), methyl nonafluoroisobutyl ether (HFE-7100), ethyl nonafluorobutyl ether (HFE-7200), ethyl nonafluoroisobutyl ether (HFE-7200), 1,1,2,2-tetrafluoroethyl-2,2,2-trifluoroethyl ether, etc.); volatile methylsiloxane solvents (e.g., hexamethyldisiloxane (OS-10, Dow Corning), octamethyltrisiloxane (OS-20, Dow Corning), decamethyltetrasiloxane (OS-30, Dow Corning), etc.), including mixtures thereof.

Any suitable cleaning apparatus may be used, including but not limited to those described in U.S. Pat. Nos. 5,248,456; 5,482,659, 6,660,208; 6,996,245; and 8,529,703.

A preferred wash apparatus is a Carbon, Inc. smart part washer, available from Carbon, Inc., 1089 Mills Way, Redwood City, Calif. 94063 USA. Thus in some embodiments, the wash step, when included, may be carried out by immersing the objectsite article in a wash liquid such as described above, with agitation (e.g., by rotating the composite article in the wash liquid), optionally but preferably with the wash step carried out in a total time of 10 minutes or less.

Further curing. While further (or second) curing may be carried out by any suitable technique, including but not limited to those described in U.S. Pat. No. 9,453,142. In a preferred embodiment, the further curing is carried out by heating.

Heating may be active heating (e.g., in an oven, such as an electric, gas, solar oven or microwave oven, or combination thereof), or passive heating (e.g., at ambient temperature). Active heating will generally be more rapid than passive heating and in some embodiments is preferred, but passive heating—such as simply maintaining the intermediate at ambient temperature for a sufficient time to effect further cure—is in some embodiments preferred. Ovens may be batch or continuous (conveyor) ovens, as is known in the art.

Conveyor ovens are in some embodiments preferred, including multi-zone conveyor ovens and multi-heat source conveyor ovens, and associated carriers for objects that can serve to provide more uniform or regular heat to the object being cured. The design of conveyor heating ovens, and associated controls, are well known in the art. See, e.g., U.S. Pat. Nos. 4,951,648; 5,179,265; 5,197,375; and 6,799,712.

In some embodiments, the heating step is carried out at at least a first (oven) temperature and a second (oven) temperature, with the first temperature greater than ambient temperature, the second temperature greater than the first temperature, and the second temperature less than 300° C. (e.g., with ramped or step-wise increases between ambient temperature and the first temperature, and/or between the first temperature and the second temperature). In some embodiments, the heating step is carried out at at least a first (oven) temperature and a second (oven) temperature, with the first temperature greater than ambient temperature, the second temperature greater than the first temperature, and the second temperature less than 300° C. (e.g., with ramped or step-wise increases between ambient temperature and the first temperature, and/or between the first temperature and the second temperature).

For example, the intermediate may be heated in a stepwise manner at a first temperature of about 70° C. to about 150° C., and then at a second temperature of about 150° C. to 200 or 250° C., with the duration of each heating depending on the size, shape, and/or thickness of the intermediate. In another embodiment, the intermediate may be cured by a ramped heating schedule, with the temperature ramped from ambient temperature through a temperature of 70 to 150° C., and up to a final (oven) temperature of 250 or 300° C., at a change in heating rate of 0.5° C. per minute, to 5° C. per minute. (See, e.g., U.S. Pat. No. 4,785,075).

Heating is preferably carried out by directly contacting the composite article (or at least a major portion of the composite article, as the article will typically be placed on a support tray or remain adhered to a carrier platform) to a heated gas, such as heated air, in an oven such as a convection oven.

The foregoing is illustrative of the present invention, and is not to be construed as limiting thereof. The invention is defined by the following claims, with equivalents of the claims to be included therein.

1. In an assembly useful for preparing a prosthetic crown for fitting to a tooth of a patient comprising (a) a polymer dental model having a shape corresponding to at least a portion of a dental arch of a patient and a socket formed therein, the socket having a socket wall, and (b) a polymer die having an upper portion configured in the shape of a tooth of a patient and a lower stem configured for insertion into said socket, the improvement comprising:
configuring at least one of said stem and said said socket wall to have both a relaxed position when said die is not in said socket, and a tensioned position when said die is fully inserted in said socket, so that said stem is firmly and accurately engaged by said socket when said die is inserted therein.

2. An assembly useful for preparing a prosthetic crown for fitting to a tooth of a patient of claim 1, comprising:
(a) a polymer dental model having a shape corresponding to at least a portion of a dental arch of a patient, said model having (i) a bottom surface portion and (ii) a socket formed in said model in a location corresponding to a tooth of a patient, to which tooth a crown is to be fitted, with said socket extending through said bottom surface portion, and with said socket having a side wall and an irregularly shaped circumference; and
(b) a polymer die having an upper portion configured in the shape of a tooth of a patient prepared to receive a crown and a lower stem configured for insertion into said socket, with said stem having (i) a bottom surface portion and (ii) an irregularly shaped circumference corresponding to that of said socket, the stem and socket together configured so that said die inserts into said socket in one orientation only;
with said stem comprising at least two separate elongate prongs configured for insertion into said socket, each said prongs having a laterally relaxed position and a laterally tensioned position;
and with said prongs configured so that upon insertion into said socket with said stem bottom portion co-planar with said dental model bottom portion, said prongs in said tensioned position frictionally engage said socket wall and securely position said die in said model in a predetermined position.

3. The assembly of claim 2, wherein said prongs are either (i) free of one another adjacent said bottom surface portion, or (ii) connected to one another adjacent said bottom surface portion.

4. The assembly of claim 2, wherein said prongs in said relaxed position are warped away from one another.

5. An assembly useful for preparing a prosthetic crown for fitting to a tooth of a patient of claim 1, comprising:
(a) a polymer dental model having a shape corresponding to at least a portion of a dental arch of a patient, said model having (i) a bottom surface portion and (ii) a socket formed in said model in a location corresponding to a tooth of a patient, to which tooth a crown is to be fitted, with said socket extending through said bottom surface portion, and with said socket having a side wall and an irregularly shaped circumference; and
(b) a polymer die having an upper portion configured in the shape of a tooth of a patient prepared to receive a crown and a lower stem configured for insertion into said socket, with said stem having (i) a bottom surface portion and (ii) an irregularly shaped circumference corresponding to that of said socket, the stem and socket together configured so that said die inserts into said socket in one orientation only;
with said socket comprising at least one, or a plurality of, wall portions having a laterally relaxed position and a laterally tensioned position;
and with said wall portions configured so that upon insertion into said socket with said stem bottom portion co-planar with said dental model bottom portion, said wall portions in said tensioned position frictionally engage said stem and securely position said die in said model in a predetermined position (plus or minus 20 microns in the mesial distal axis, and/or plus or minus 20 microns in the buccal lingual axis).

6. The assembly of claim 1, wherein said stem in said tensioned position, and said socket, are inwardly tapered in a corresponding mating configuration.

7. The assembly of claim 1, wherein:
said socket has a top opening and a bottom opening,
said socket top opening has a circumference greater than said socket bottom opening,
said socket side wall tapers inwardly from said socket top opening to said socket bottom opening; and
said stem bottom portion has a circumference intermediate between that of said socket top opening and that of said socket bottom opening.

8. The assembly of claim 1, wherein said stem further comprises a narrowed foot portion adjacent said bottom surface portion.

9. The assembly of claim 1, wherein both said model and said die are comprised of poly(acrylate), poly(methacrylate), poly(urethane acrylate), poly(urethane methacrylate), poly(epoxy acrylate), or poly(epoxy methacrylate).

10. The assembly of claim 1, wherein both said model and said die consist of a polymer having:
a tensile modulus of 1200 or 1600 MPa to 3000 MPa, or more;
an elongation at break of 2% to 100 or 140%, or more;
a flexural strength of 40 or 60 MPa, to 100 or 120 MPa, or more; and/or
a flexural modulus (chord, 0.5%-1% strain) of 1500 or 2000 MPa, to 3000 MPa, or more.

11. The assembly of claim 1, wherein both said dental model and said die are produced by additive manufacturing from a polymerizable resin.

12. The assembly of claim 1, wherein said dental model is layerless, said die is layerless, or both said dental model and said die are layerless.

13. A method of making an assembly of claim 1, comprising:
(a) producing both said die and said model from a light-polymerizable resin by stereolithography, preferably bottom-up stereolithography, and then
(b) optionally washing said die and said model.

14. The method of claim 13, wherein said resin shrinks during or after said producing step, and wherein said prongs warp away from one another during or after said producing step.

15. The method of claim 13, wherein said producing step is carried out in a time of not more than one hour.

16. The method of claim 13, wherein said producing step is carried out on a stereolithography apparatus including a carrier platform, and said producing step comprises simultaneously producing said die and said model on the same carrier platform.

17. The method of claim 13, wherein said bottom-up stereolithography comprises continuous liquid interface production.

18. The assembly of claim 1, wherein said stem is firmly and accurately engaged at plus or minus 20 microns in the mesial-distal axis of the arch or arch portion, and/or plus or minus 20 microns in the buccal-lingual axis of the arch or arch portion by said socket when said die is inserted therein.
